(19) United States
(12) Patent Application Publication
(10) Pub. No.: US 2010/0241474 A1
(43) Pub. Date: Sep. 23, 2010

(54) ASSEMBLY SUPPORT APPARATUS AND METHOD FOR ASSEMBLY SUPPORT

(75) Inventors: Yoshitomo Kumagai, Kawasaki (JP); Toshiro Okada, Kawasaki (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: FUJITSU LIMITED, Kawasaki-shi (JP)

(21) Appl. No.: 12/726,397

(22) Filed: Mar. 18, 2010

(30) Foreign Application Priority Data
Mar. 19, 2009 (JP) 2009-069108

(51) Int. Cl. G06Q 10/00

(52) U.S. Cl. 705/7

(57) ABSTRACT

A assembly support apparatus for promotion of an information system, includes a memory for storing design information of the information system including information of a plurality of components necessary for the production of the information system; and a processor for generating instructions for procurement of the components in accordance with a process comprising; discriminating the components into those available as inventory items and those that need to be procured from the exterior on the basis of the design information stored in the memory, urging information of persons responsible to procure the component to be inputted in association with those components to be inputted in association with those components to be produced respectively, and generating instructions directed to the responsible persons for procurement of those components to be procured from the exterior respectively.

### CROSS-REFERENCE TO RELATED APPLICATION

This application is based upon and claims the benefit of priority of the prior Japanese Patent Application No. 2009-069108, filed on Mar. 19, 2009, the entire contents of which are incorporated herein by reference.

### FIELD

The embodiments discussed herein are related an assembly support apparatus and method for assembly support.

### BACKGROUND

Recent information systems introduced to companies have multiple functions such as network, database (DB), and operation system functions, with the diversification of information technology. Planning, designing, construction, introduction, updating and maintenance of the information systems are collectively managed using system integration. (For example, Japanese Laid-open Patent Publication No. 2003-331170)

However, more than one person are involved with ordering, management, etc. of resources and devices related to the integration of information systems, and persons who order and manage the resources and devices are managed using a manually prepared document. Therefore, it can hardly be said that data for the integration of information systems is efficiently managed, which is an obstacle to execution of the system integration. For example, when newly adding a device and updating the system in a network or DB, it may collect documents related to the ordering and management of the device, to verify the contents of the collected documents, and thereafter to prepare a document on the ordering and management of the device related to the update of the system.

### SUMMARY

According to an aspect of the embodiments, an apparatus for promotion of an information system, includes a memory for storing design information of the information system including information of a plurality of components necessary for the production of the information system; and a processor for generating instructions for procurement of the components in accordance with a process comprising; discriminating the components into those available as inventory items and those that need to be procured from the exterior on the basis of the design information stored in the memory, urging information of persons responsible to procure the component to be inputted in association with those components to be inputted in association with those components to be produced respectively, and generating instructions directed to the responsible persons for procurement of those components to be procured from the exterior respectively.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a data management apparatus according to a first embodiment;

FIG. 2 is a diagram showing an example of a network diagram;

FIG. 3 is a diagram showing an example of a configuration diagram;

FIG. 4 is a diagram showing an example of a power source diagram;

FIG. 5 is a diagram showing an example of an operation document;

FIG. 6 is a diagram showing a system configuration according to the first embodiment;

FIG. 7 is a diagram showing the configuration of the data management apparatus according to the first embodiment;

FIG. 8 is a diagram showing the outline of generation of an operation document according to the first embodiment;

FIG. 9 is a diagram showing an example of default definition of do-order information set at the creation of a new drawing according to the first embodiment;

FIG. 10 is a diagram showing a default insertion example of do-order information according to the first embodiment;

FIG. 11 is a diagram of an example of edition of do-order information according to the first embodiment;

FIG. 12 is a diagram showing an example of the output of do-order information” according to the first embodiment;

FIG. 13 is a diagram showing examples of abbreviated name of do-not-order information according to the first embodiment;

FIG. 14 is a diagram showing an example of the default definition of do-not-order information according to the first embodiment;

FIG. 15 is a diagram showing an example of the definition of selection of do-not-order information according to the first embodiment;

FIG. 16 is a diagram showing the link structure of the order information and the item information according to the first embodiment;

FIG. 17 is a diagram showing the link structure of the item information and the circuit diagram according to the first embodiment;

FIG. 18 is a detail diagram of symbol shape data according to the first embodiment;

FIG. 19 is a diagram showing an example of the link structure of the order information and the item information according to the first embodiment;

FIG. 20 is a diagram showing the link structure of an item library according to the first embodiment;

FIG. 21 is a diagram showing an example of the configuration of the order information according to the first embodiment;

FIG. 22 is a diagram showing an example of the output of the operation document according to the first embodiment;

FIG. 23 is a diagram showing an example of the output of the item information according to the first embodiment;

FIG. 24 is a diagram showing an example of the output of component information according to the first embodiment;

FIG. 25 is a flowchart for the process according to the first embodiment;

FIG. 26 is a diagram for explaining the changing of element attributes of an item according to a second embodiment;

FIG. 27 is a diagram for explaining the changing of element attributes of an item according to the second embodiment;

FIG. 28 is a diagram for explaining the changing of element attributes of an item according to the second embodiment;

FIG. 29 is a flowchart for the process according to the second embodiment;

FIG. 30 is a diagram showing comparison objects between order information according to a third embodiment;

FIG. 31 is a diagram showing an example of the extraction of order information according to the third embodiment;

FIG. 32 is a diagram showing an example of the display of the difference between order information according to the third embodiment;

FIG. 33 is a flowchart for the process according to the third embodiment; and

FIG. 34 is a diagram showing a display example of a dialog for setting common order items and attachments according to a fourth embodiment.

### BRIEF DESCRIPTION OF EMBODIMENTS

### First Embodiment

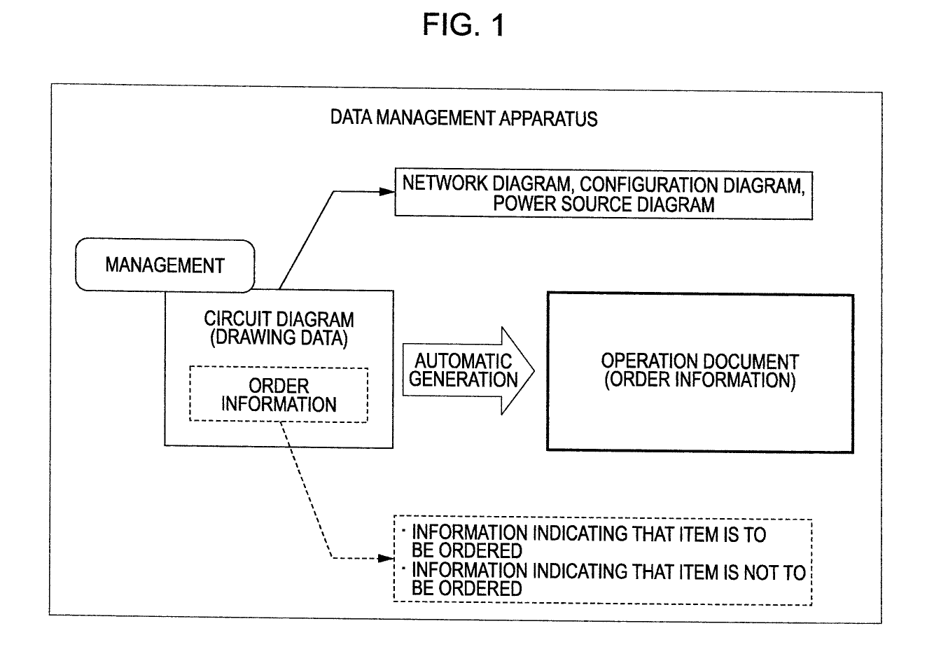

FIG. 1 is a diagram for explaining a data management apparatus according to a first embodiment. As shown in the drawing, the essence of the data management apparatus according to the first embodiment is to manage the order information of items arranged in circuit diagrams in association with the individual items for each of the circuit diagrams (drawing data) and to generate an operation document indicating the details of the order status.

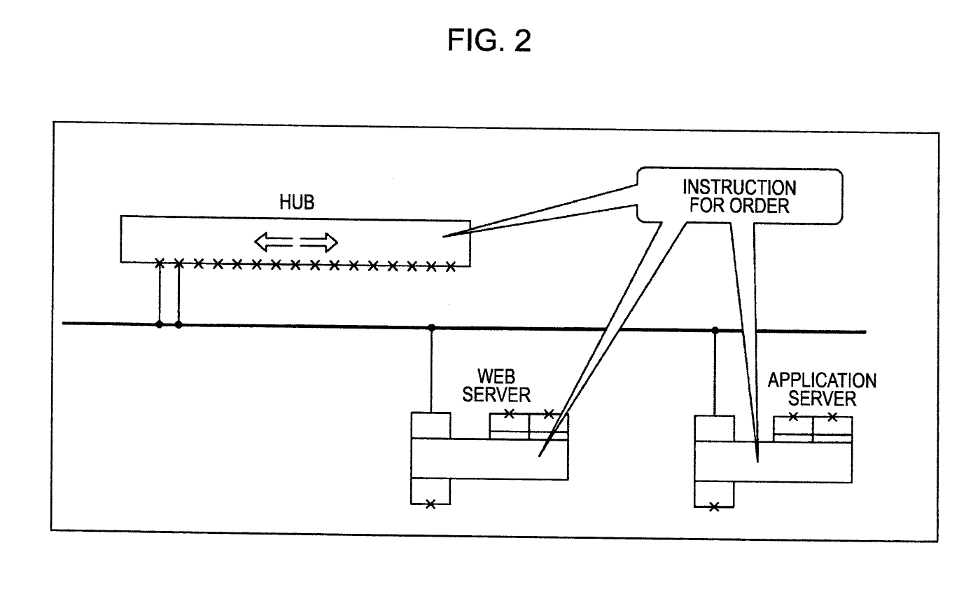

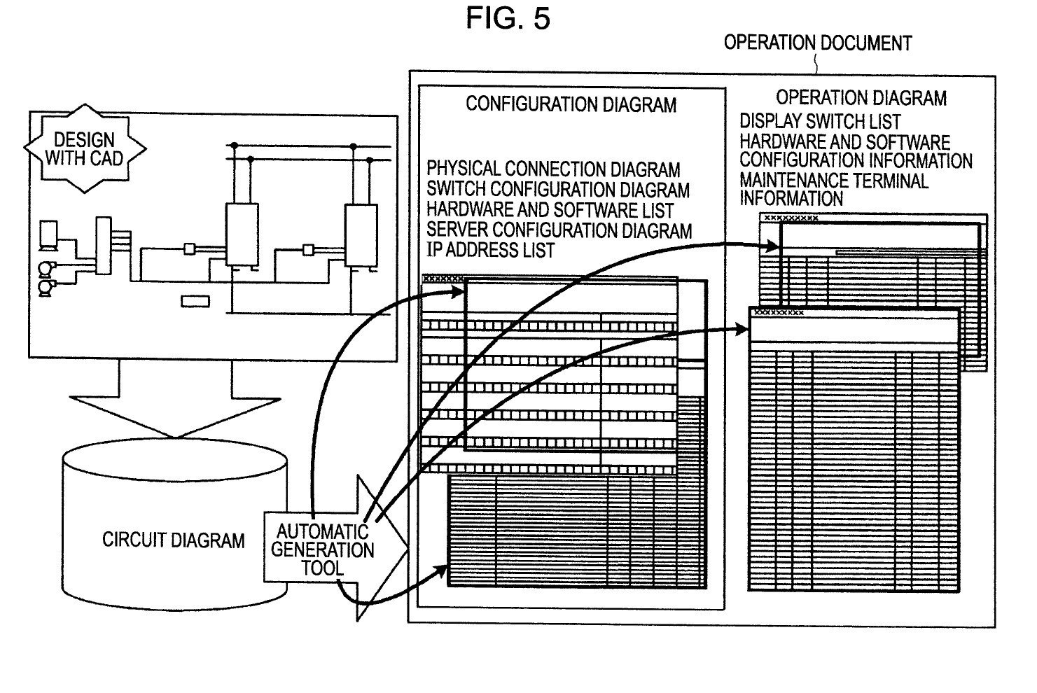

Here, the order information refers to, for example, information that indicates ordering an item for constructing a system (hereinafter, referred to as do-order information) and information that indicates not ordering an item for constructing a system (hereinafter, referred to as do-not-order information). The circuit diagram refers to drawing data describing a network diagram, a configuration diagram, and a power source diagram, as shown in FIGS. 2 to 4. The operation document refers to information in which circuit diagrams (drawing data) and order information are associated with each other (see FIG. 5).

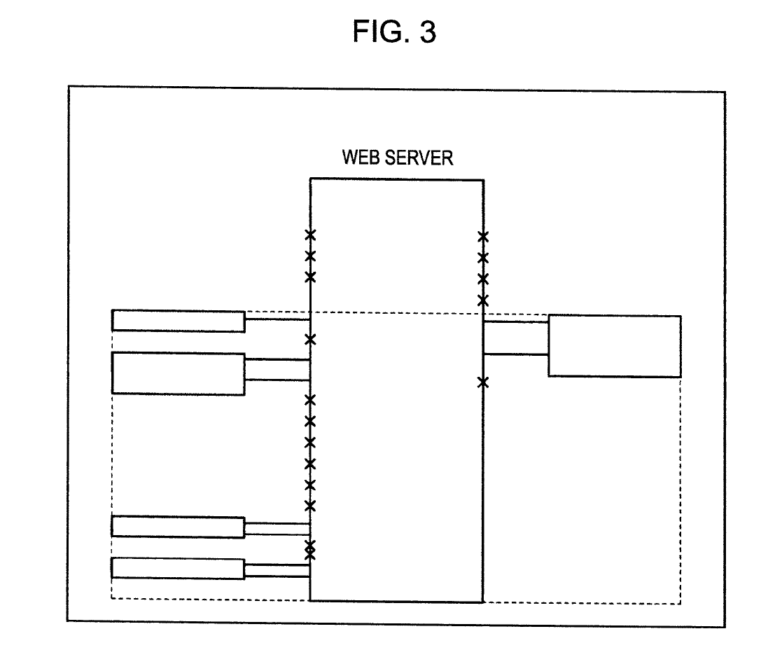

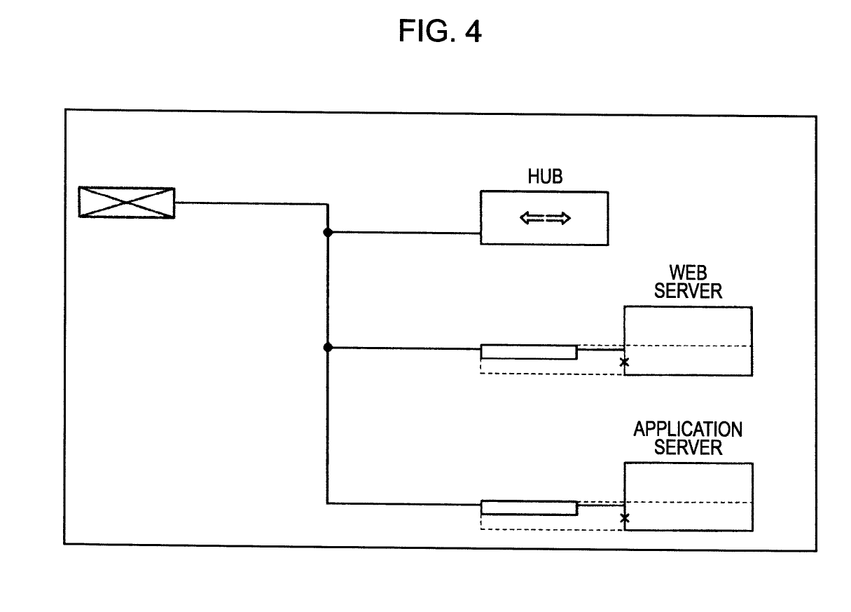

FIG. 2 is a diagram showing an example of the network diagram. FIG. 3 is a diagram showing an example of the configuration diagram. FIG. 4 is a diagram showing an example of the power source diagram. FIG. 5 is a diagram showing an example of the operation document. The data management apparatus according to the first embodiment will be described herein below.

### Configuration According to First Embodiment

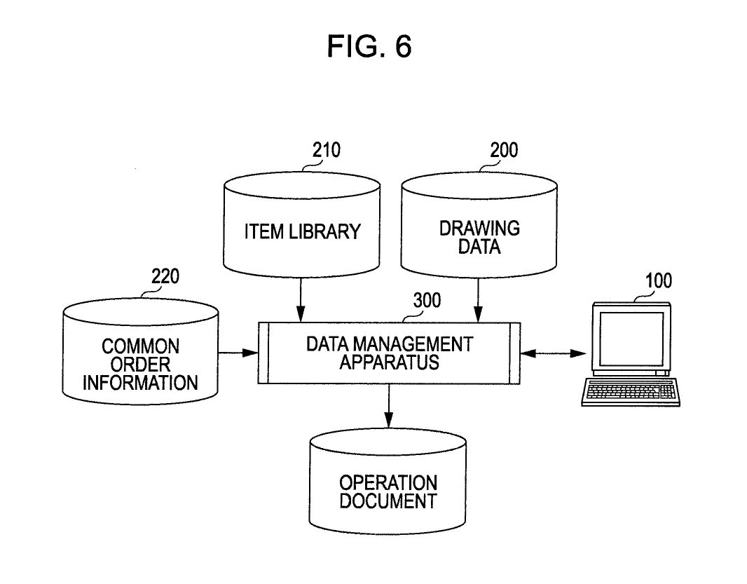

FIG. 6 is a diagram showing a system configuration according to the first embodiment. As shown in the diagram, the data management apparatus 300 according to the first embodiment is accessible to a user device 100, drawing data 200, an item library 210, and common order information 220.

The drawing data 200 is drawing data of a circuit diagram including order information. The item library 210 includes, as information indicating a reason of not ordering an item when the item is not ordered, definition information for selecting an abbreviated name from a plurality of “abbreviated names” included in the common order information 220. The common order information 220 is data including “do-order information” set by default when a new circuit diagram is created and “do-not-order information” that is presented to the designer as an option when the item is not ordered.

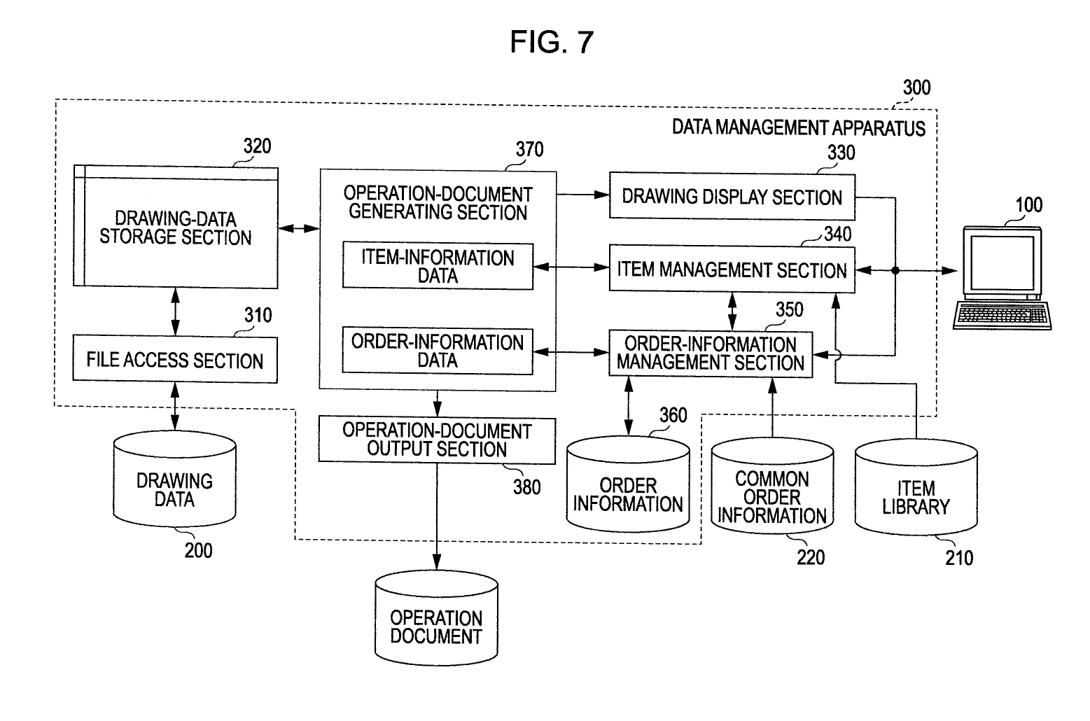

As shown in FIG. 7, the data management apparatus 300 includes a file access section 310, a drawing-data storage section 320, a drawing display section 330, an item management section 340, an order-information management section 350, order information 360, an operation-document generating section 370, and an operation-document output section 380. FIG. 7 is a diagram showing the configuration of the data management apparatus 300 according to the first embodiment.

The file access section 310 accesses the drawing data 200. The drawing-data storage section 320 stores drawing data that the file access section 310 acquires from the drawing data 200. The drawing display section 330 outputs the drawing data to the user device 100 for display. The item management section 340 manages the item library 210. The order-information management section 350 manages the common order information 220 and the order information 360. The order information 360 is data managed in a predetermined file format (for example, the CSV format) by the order-information management section 350.

The operation-document generating section 370 automatically generates an operation document from the data of the circuit diagram (drawing data) including order information. The operation-document output section 380 outputs an operation document generated by the operation-document generating section 370 in a predetermined file format (for example, the CSV format).

The data management apparatus 300 in the embodiment physically is a computer that includes the processor and a storage device (such as a hard disk). In addition, a drawing display program, an item management program, an order-information program, an operation document generation program, an operation management program, and a file access program are at least stored in the storage unit.

The processor functions by executing these programs respectively as the drawing display section 330, the item management section 340, the order-information section 350, the operation document generation section 370, the operation management section 380, and the file access section 310.

### Outline of Generation of Operation Document

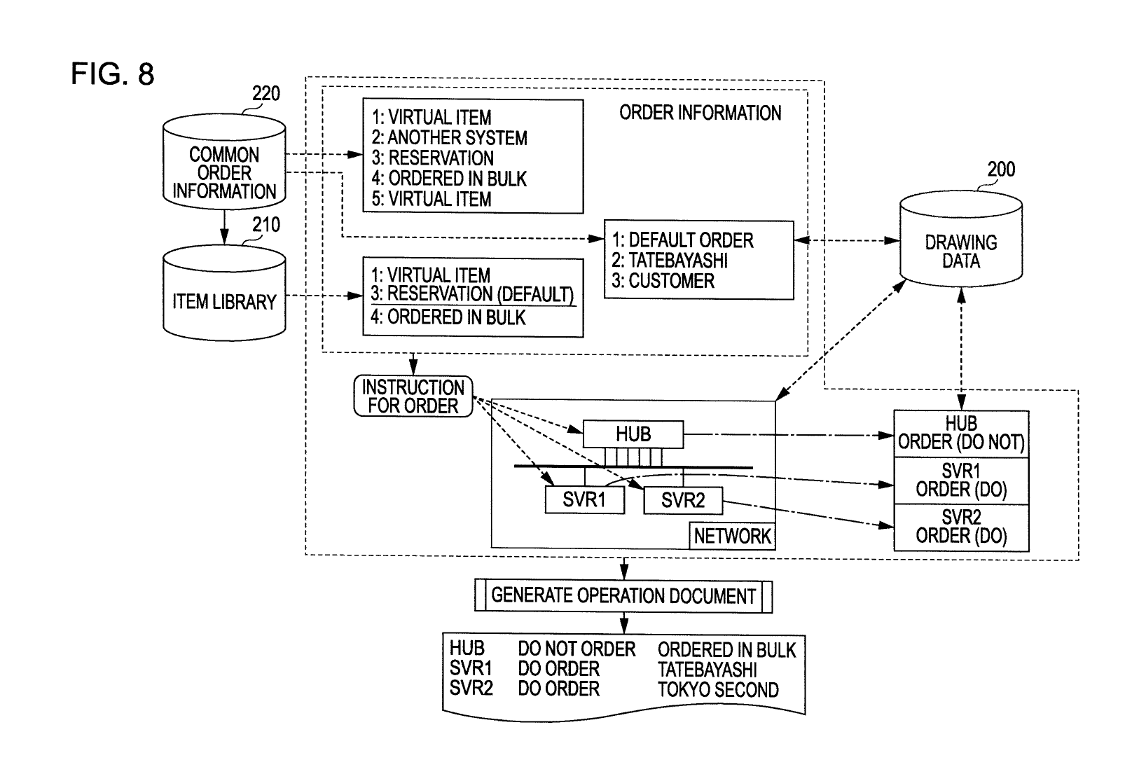

FIG. 8 is a diagram showing the outline of generation of an operation document according to the first embodiment. As shown in the diagram, when creating a network diagram, the designer inputs order information to issue an instruction for order to “HUB (hub)”, “SVR (server) 1”, and “SVR (server) 2” in the network diagram.

For example, as shown in FIG. 8, order information, such as “HUB (hub)”→“DO NOT ORDER”, “SVR (server) 1”→“DO ORDER”, “SVR (server) 2”→“DO ORDER, is input. The data management apparatus 300 manages the order information of items in the circuit diagram in association with the individual items for each circuit diagram (drawing data). When an instruction to output an operation document for the network diagram, the data management apparatus 300 automatically generates an operation document showing the details of order information associated with the items in the network diagram using an automatic generation tool.

For the order information included in “do-order information” in the circuit diagram (drawing data), the designer inputs “abbreviated name” and “ordering means” of an order destination for the individual items.

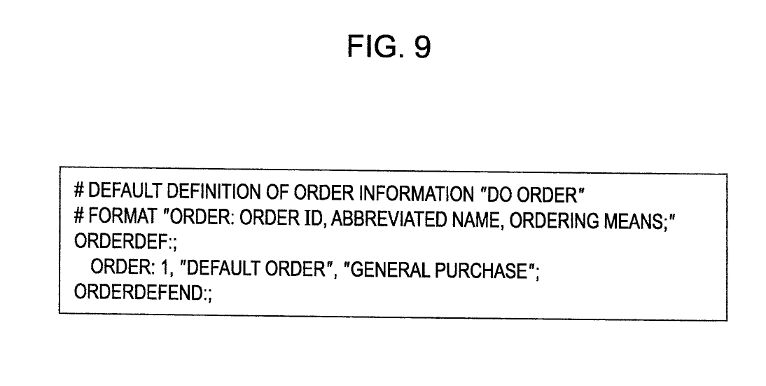

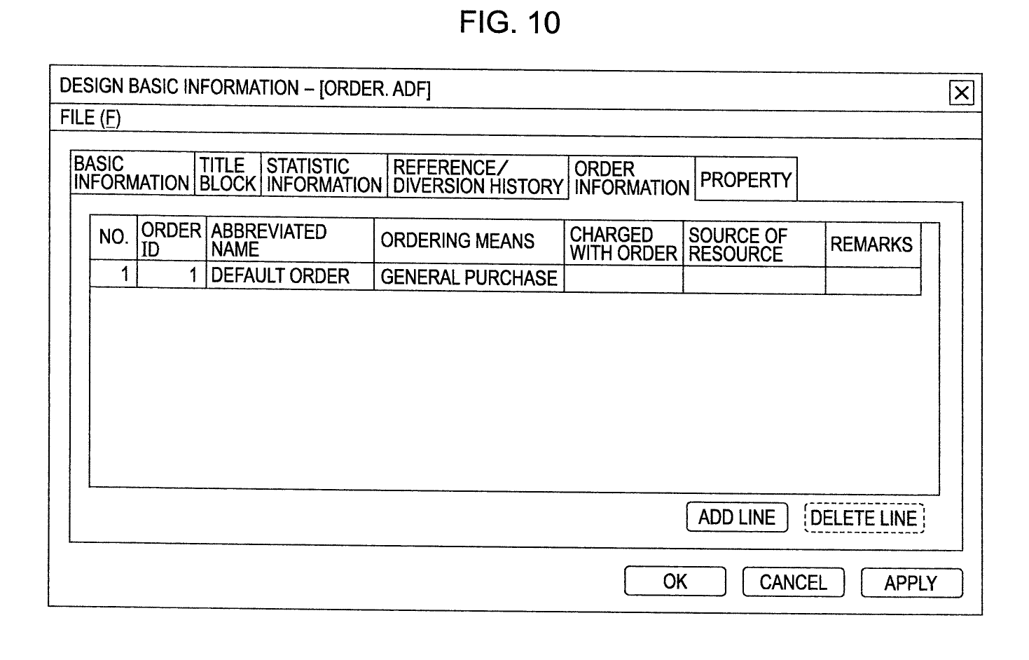

Supplementary explanation of the input of “do-order information” will be given herein below. As shown in FIG. 9, for example, the common order information 220 includes definition information that defines default “do-order information” that is automatically set for the individual items when a new drawing of the circuit diagram is created. As shown in FIG. 10, default “do-order information” (order ID→1, abbreviated name default order, ordering means→general purchase) is inserted into a dialog at the creation of the new drawing. FIG. 9 is a diagram showing an example of default definition of do-order information set at the creation of a new drawing according to the first embodiment. FIG. 10 is a diagram showing a default insertion example of do-order information according to the first embodiment.

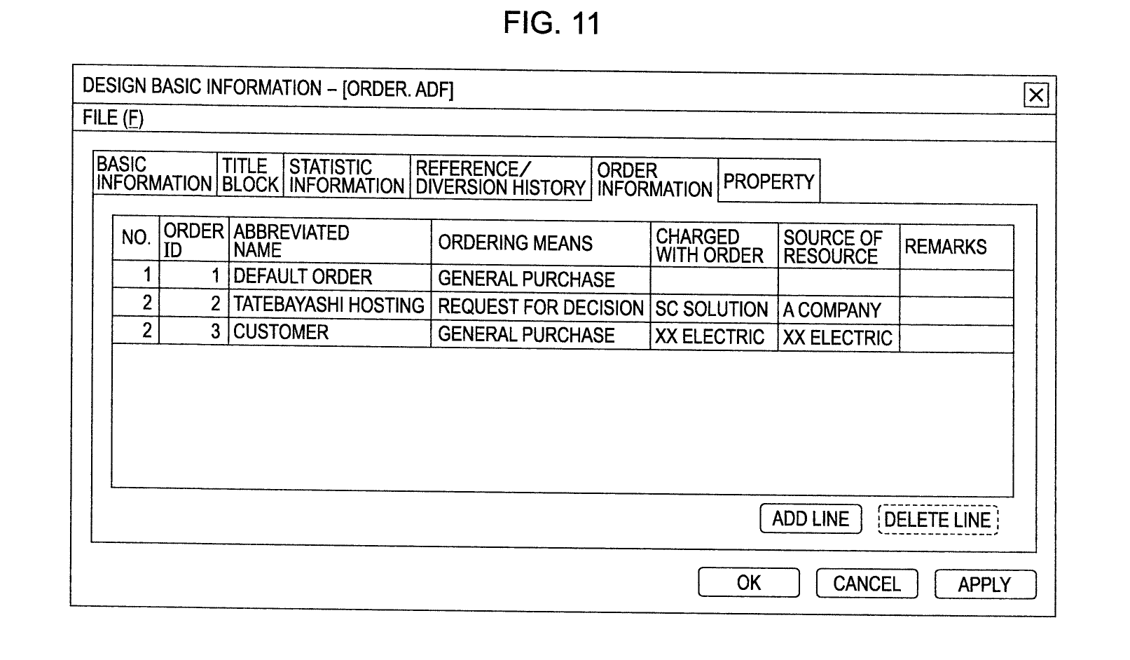

As shown in FIG. 11, when the designer executes edition of “do-order information”, order information can be inserted or deleted by selecting “add line” or “delete line” in the dialog. FIG. 11 is a diagram showing an example of edition of do-order information according to the first embodiment.

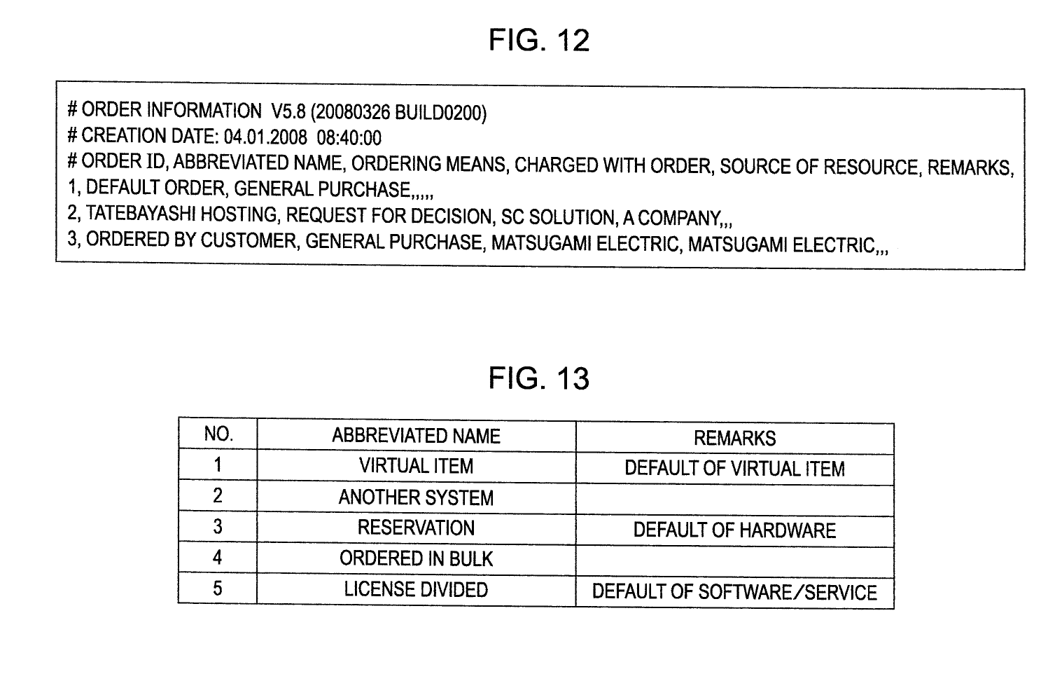

“Do-order information”, shown in FIG. 12, is output in the CSV format, as shown in FIG. 9, and is stored as the order information 360. FIG. 12 is a diagram showing an example of the output of do-order information according to the first embodiment.

For order information included as “do-not-order information” in the circuit diagram (drawing data), the designer selects and inputs a plurality of “abbreviated names” included in the common order information 220, as information indicating the reason why the item is not ordered on the basis of selection definition included in the item library 210.

Supplementary explanation of the selection and input of “do-not-order information” will be given herein below. As shown in FIG. 13, “abbreviated name” indicating the reason of not ordering includes “No. 1: virtual item” “No. 2: another system”, “No. 3: reservation”, “No. 4: ordered in bulk”, and “No. 5: license divided”. Here, “virtual item” refers to an item that cannot be ordered via the Internet or the like; “another system” refers to avoiding duplicate order with another system; “reservation” refers to reservation of resources, such as a rack and a power source, in preparation for installing an additional item to the system; “ordered in bulk” indicates that the item is ordered in bulk; and “license divided” indicates that duplicate order in a case where the license and the item are not uniquely associated with each other. FIG. 13 is a diagram showing examples of the abbreviated name of do-not-order information according to the first embodiment.

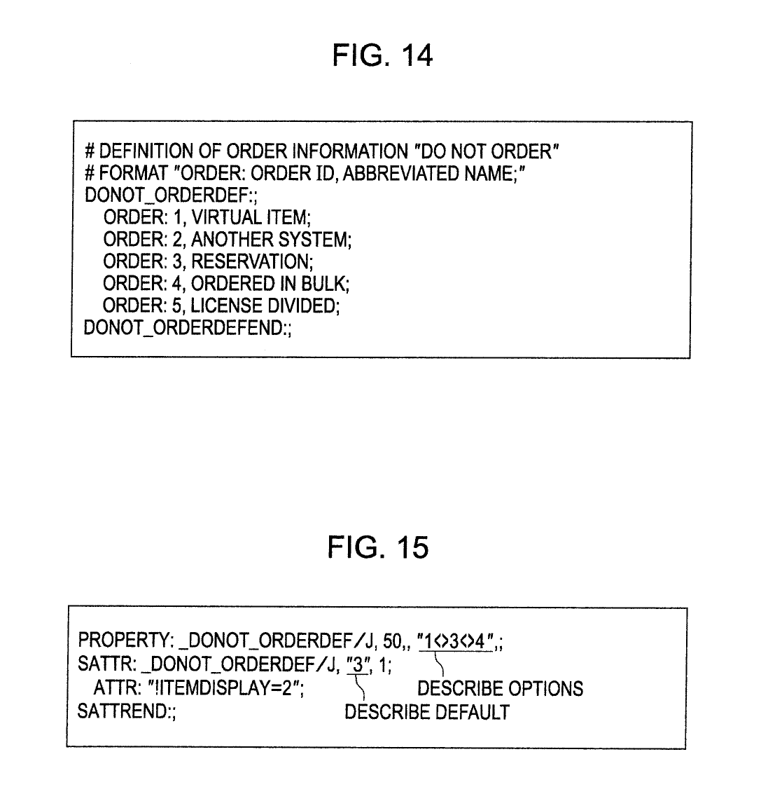

As shown in FIG. 14, the common order information 220 includes definition information that defines “abbreviated name” indicating a reason why the item is not ordered. FIG. 14 is a diagram showing an example of the default definition of do-not-order information according to the first embodiment. FIG. 15 shows the definition of selection of “do-not-order information”, in which options “virtual item”, “reservation”, and “ordered in bulk” are displayed for a case in which “do-not-order information” is input for hardware, and that “reservation” is selected by default. FIG. 15 is a diagram showing an example of the definition of selection of do-not-order information according to the first embodiment.

### Link Structure of Order Information and Item Information

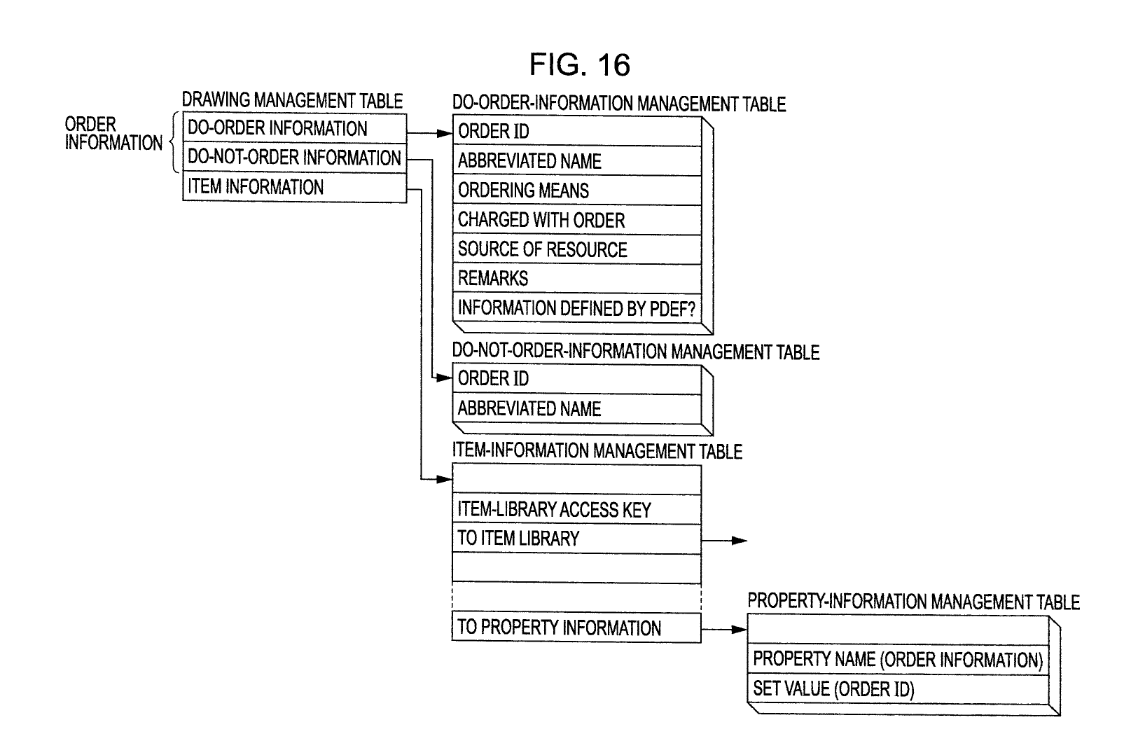

Next, a link structure of order information included in a circuit diagram (drawing data) and items in the circuit diagram will be described. As shown in FIG. 16, when creation of the circuit diagram and input of order information are completed, item information on the items in the circuit diagram and the order information are associated with each other. That is, since “order information” is set in property name and “order ID” is set in set value in “property-information management table” that is linked from “to property information” in the item information, the item information and the order information are associated with each other.

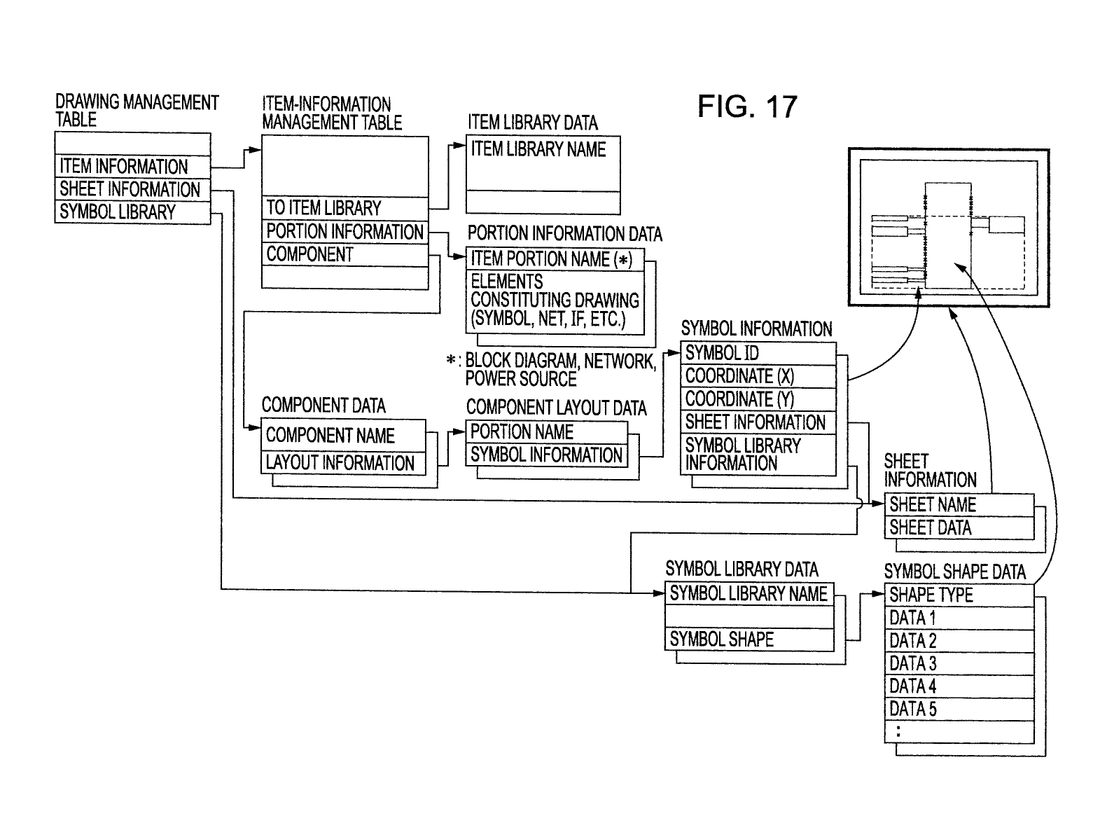

As shown in FIG. 17, the item information includes sheet information and a symbol library and links to the items arranged in the drawing data of the circuit diagram via the sheet information and symbol shape data. This allows the system designer to find the order information of any item in the drawing data of the circuit diagram, thus allowing the order information to be edited.

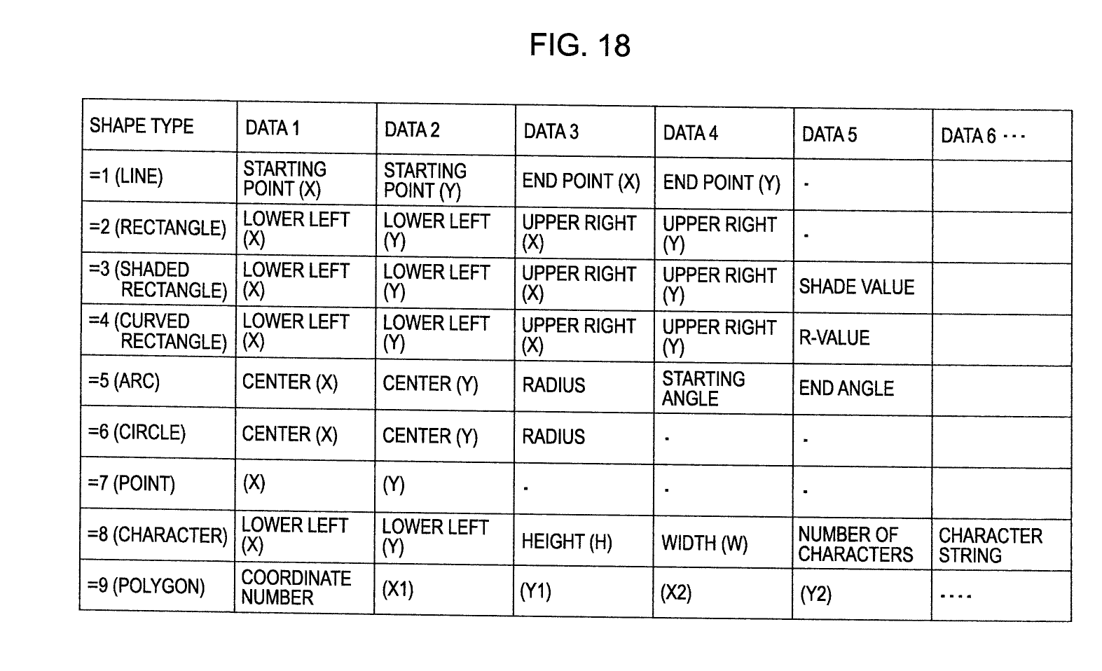

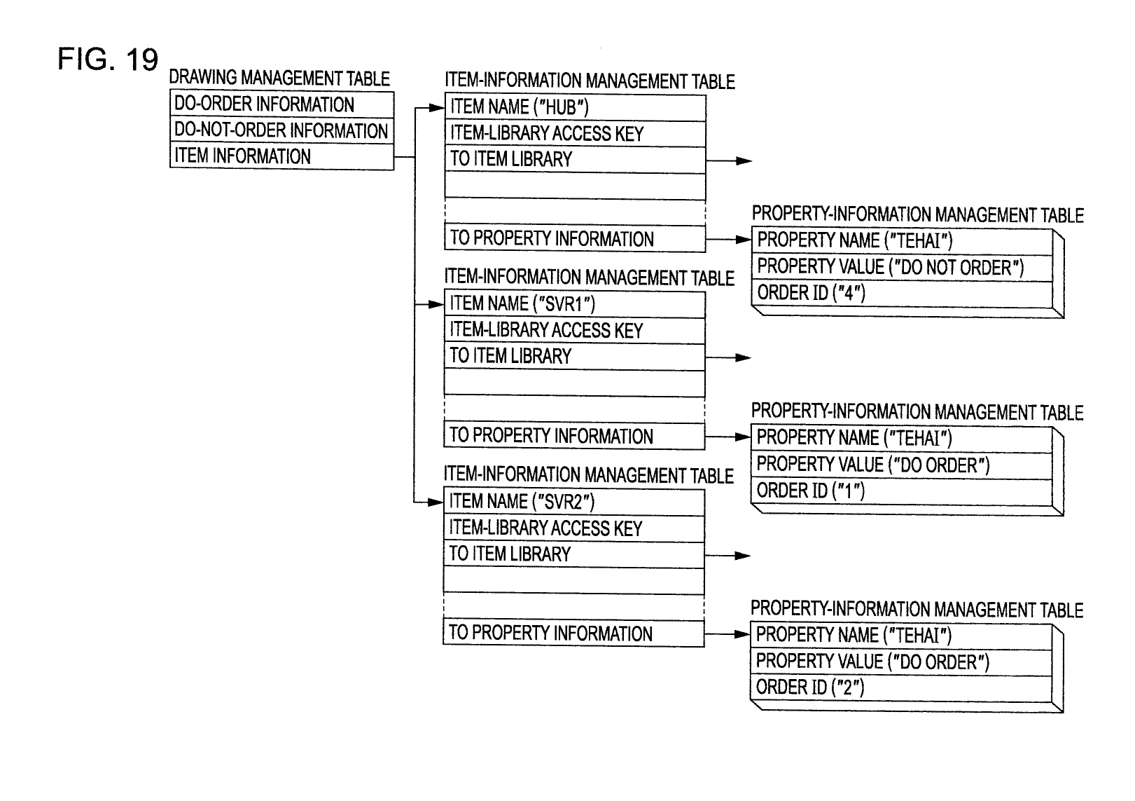

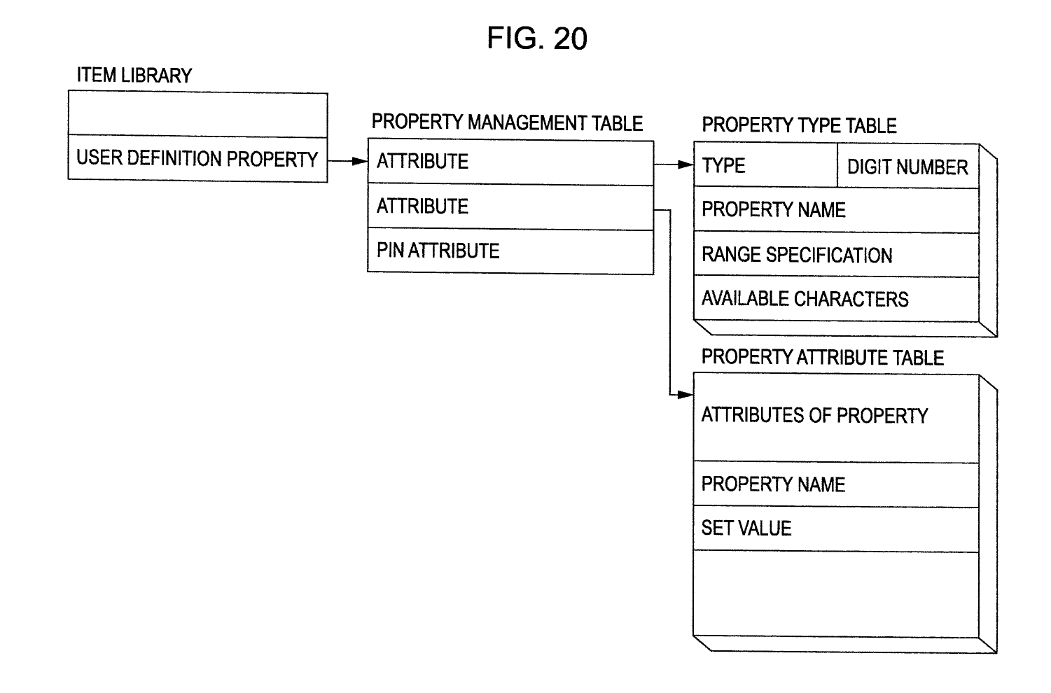

FIG. 18 shows an example of the structure of the symbol shape data. FIG. 19 shows an example of the link structure of the items “HUB (hub)”, “SVR (server) 1”, and “SVR (server) 2” on the network diagram shown in FIG. 8 and the order information of the individual items. FIG. 20 shows the link structure of the item library 210.

FIG. 16 is a diagram showing the link structure of the order information and the item information according to the first embodiment; FIG. 17 is a diagram showing the link structure of the item information and the drawing data of the circuit diagram according to the first embodiment; FIG. 18 is a detail diagram of the symbol shape data according to the first embodiment; FIG. 19 is a diagram showing an example of the link structure of the order information and the item information according to the first embodiment; and FIG. 20 is a diagram showing the link structure of the item library 210 according to the first embodiment.

### Example of Configuration of Operation Document

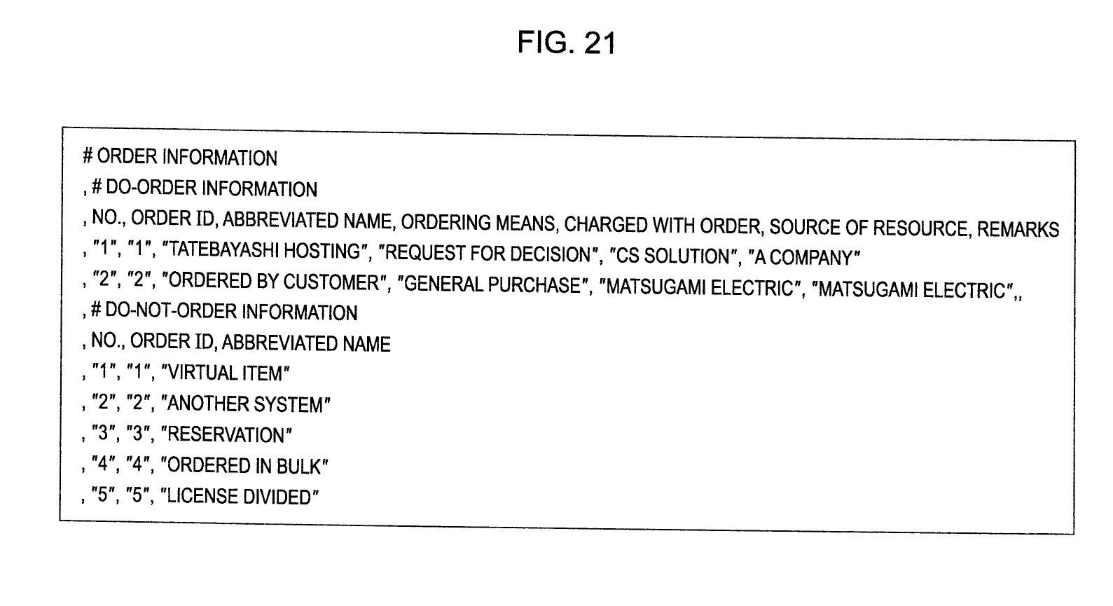

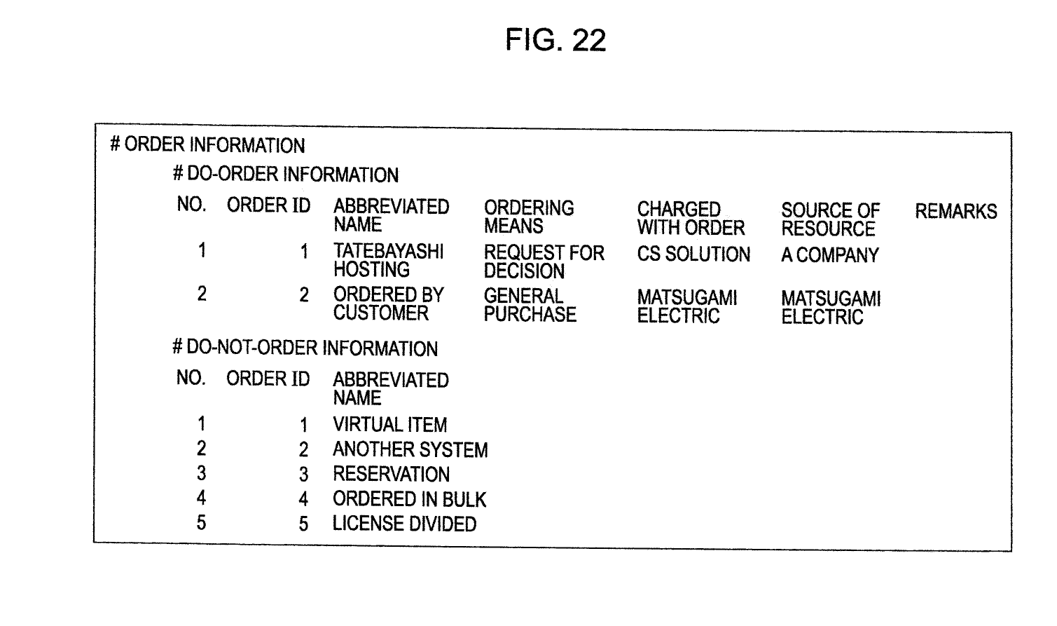

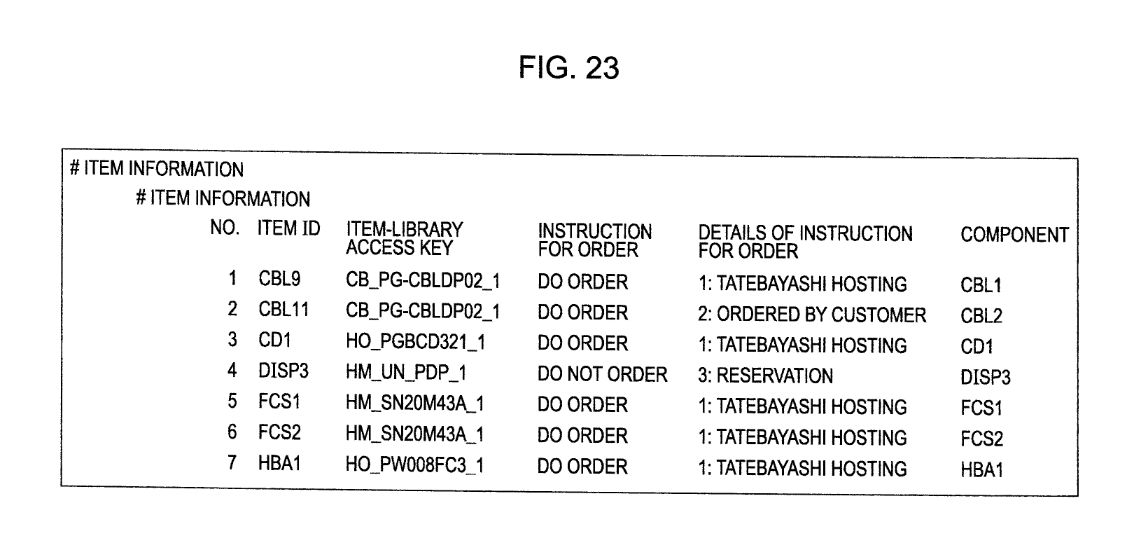

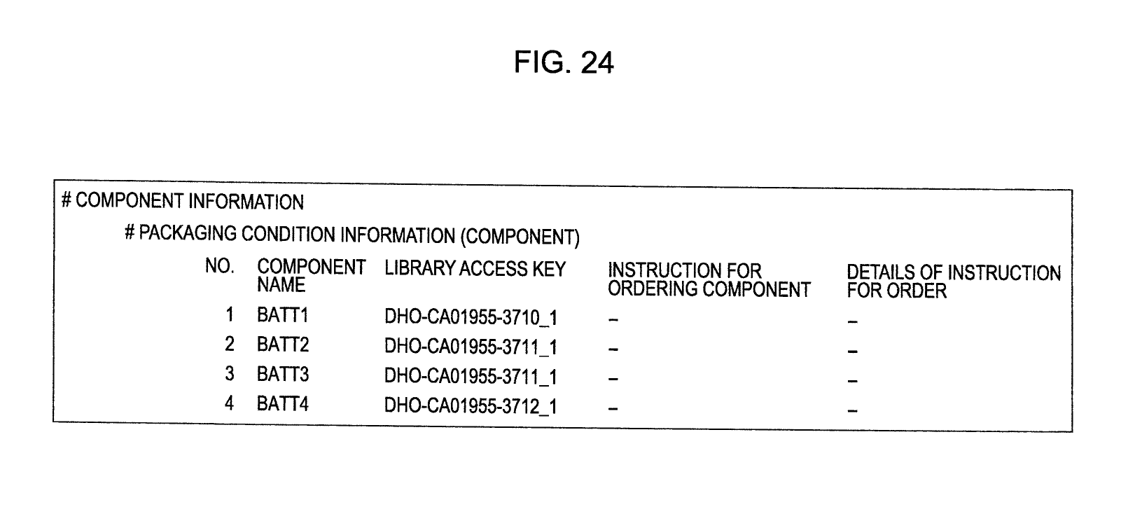

When the order information 360 configured in the CSV format (see FIG. 21) is read, for example, an operation document, as shown in FIG. 22, is output. Item information including details of instruction for order (see FIG. 23) and component information (see FIG. 24) can also be output. FIG. 21 is a diagram showing an example of the configuration of the order information according to the first embodiment; FIG. 22 is a diagram showing an example of the output of the operation document according to the first embodiment; FIG. 23 is a diagram showing an example of the output of the item information according to the first embodiment; and FIG. 24 is a diagram showing an example of the output of the component information according to the first embodiment.

### Process According to First Embodiment (Operation-Document Automatic Generation Process by Data Management Apparatus)

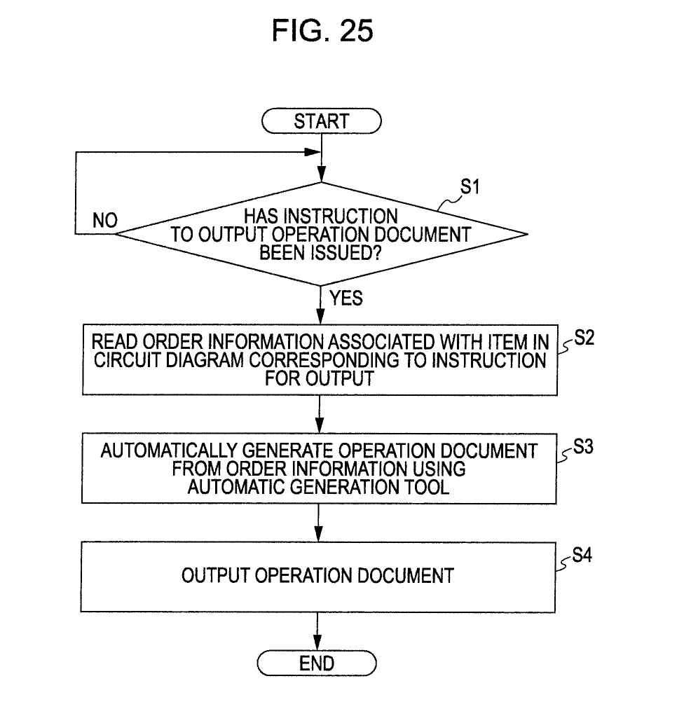

FIG. 25 is a flowchart for the process according to the first embodiment. As shown in the flowchart, when an instruction to output an operation document (Step S1: YES), the operation-document generating section 370 reads order information associated with an item in the circuit diagram corresponding to the instruction for output from the order information 360 (step S2).

The operation-document generating section 370 automatically generates an operation document from the order information using the automatic generation tool (step S3). The operation-document output section 380 outputs the operation document generated by the operation-document generating section 370 (step S4).

### Advantages of First Embodiment

As has been described above, in the first embodiment, for items to be ordered, order information that is uniquely set for the individual items in association with the item information of the items arranged in the circuit diagram. On the other hand, for items not to be ordered, information selected, from options prepared in advance using predetermined definition and common in the system, according to a reason for not ordering is managed in association with the item information. In this way, the first embodiment effectively manages the order information of items arranged in the circuit diagram in association with the individual items.

Since the first embodiment automatically generates an operation document that indicates the details of the order status of items arranged in a circuit diagram from the drawing data of the circuit diagram, system integration can be achieved smoothly. For example, in a case where it may check the order status of items drawn in a circuit diagram, the order status can be checked using an automatically generated operation document, so that loads on the system designer is remarkably reduced as compared with conventional ones.

### Second Embodiment

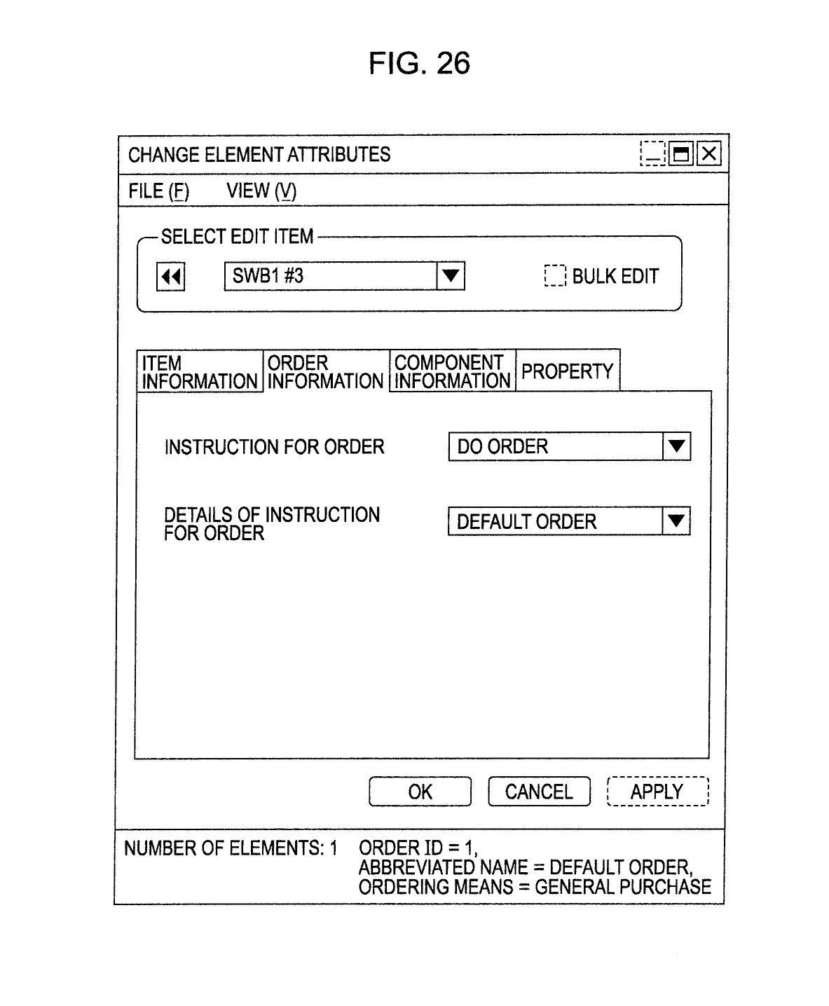

FIGS. 26 to 28 are diagrams for explaining changing of element attributes of items according to a second embodiment. The element attributes of items, such as “do-order information” (order ID, abbreviated name, or ordering means), can be changed, and the order information can be changed from “do order” to “do not order” in the first embodiment.

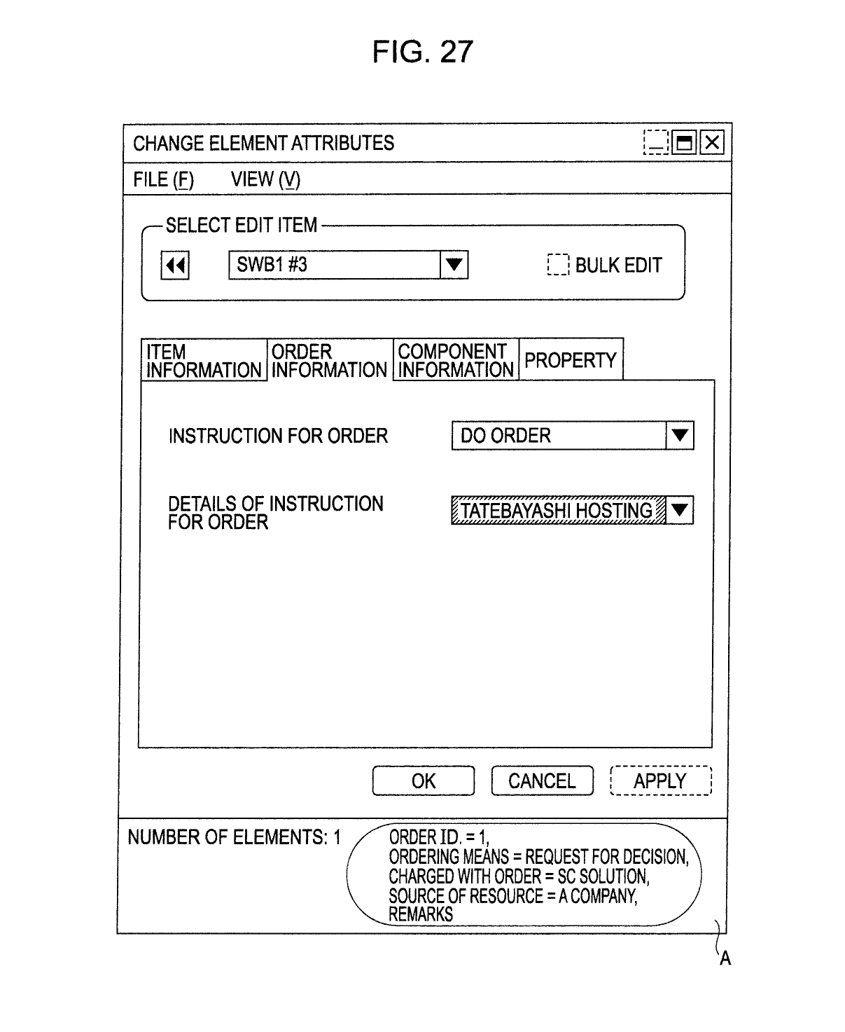

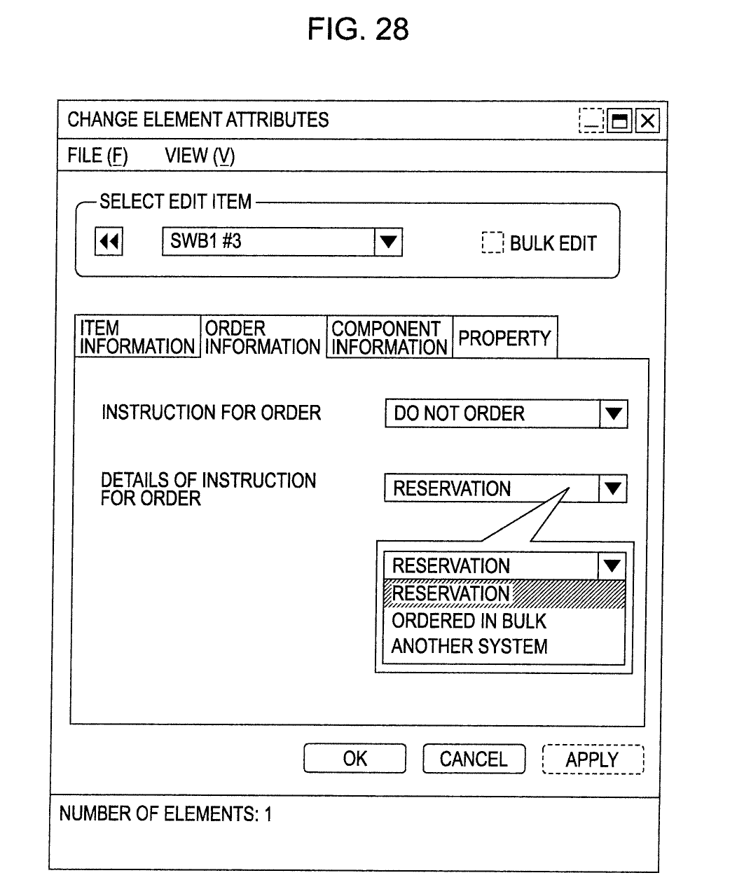

As shown in FIG. 26, the data management apparatus 300 inserts default “do-order information (order ID→1, abbreviated name→default order, ordering means→general purchase)” into the order information immediately after a new drawing is created in the circuit diagram. As shown in FIG. 27, when receiving selection of details of instruction for order from the user, the data management apparatus 300 displays information of order ID, ordering means, charged with order, source of resource, and remarks.

As shown in FIG. 28, when receiving a change of instruction for order from “do order” to “do not order”, the data management apparatus 300 inserts, for example, “reservation”, as “do-not-order information”, into the details of instruction for order by default on the basis of selection definition included in the item library 210. Furthermore, when receiving selection of the details of instruction for order from the user, the data management apparatus 300 displays options of “do-not-order information” as a dropdown list.

### Process According to Second Embodiment

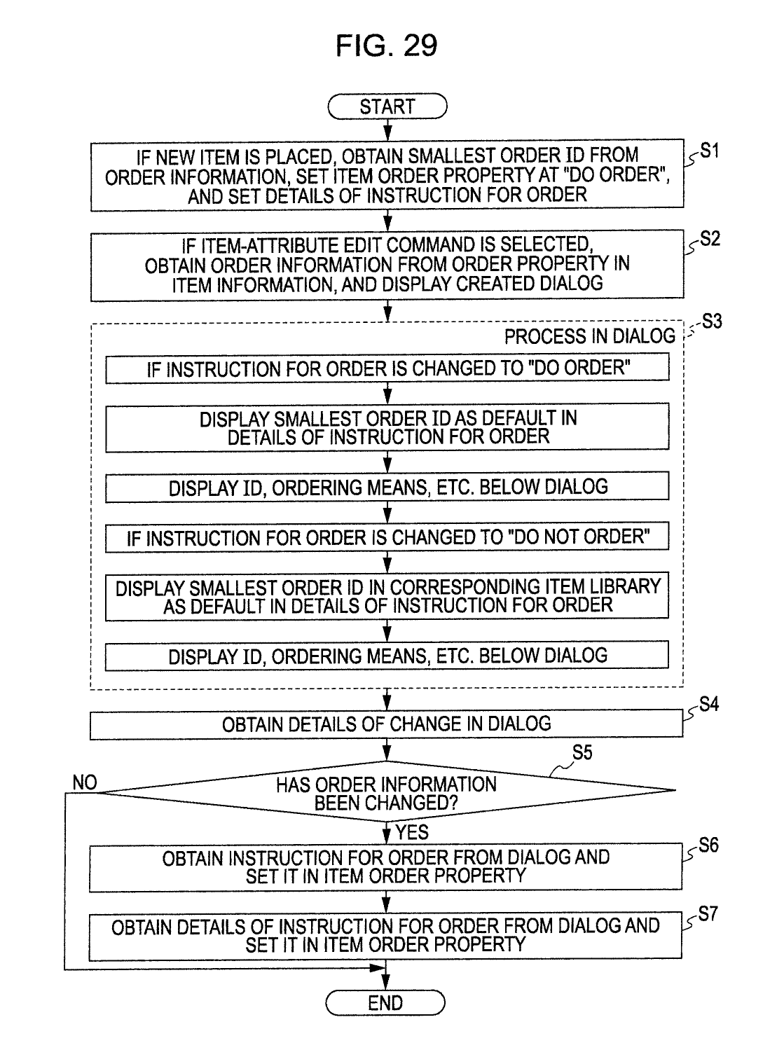

FIG. 29 is a flowchart for the process according to the second embodiment. As shown in the flowchart, when a new item is placed in the circuit diagram, the data management apparatus 300 acquires the smallest order ID from the order information 360, sets the item order property at “do order” as an instruction for order, and sets details of instruction for order (step 51).

When an item-attribute edition command is selected by the user, the data management apparatus 300 acquires order information from the order property in the item information, generates an item-attribute change dialog (for example, see FIG. 26) using the acquired order information, and displays the generated dialog (step S2).

The data management apparatus 300 executes the process in the dialog (step S3). That is, in a case where the instruction for order in the dialog is changed to “do order”, the data management apparatus 300 displays information corresponding to the smallest order ID in the order information 360 by default on the details of instruction for order and displays order ID, ordering means, etc. at the lower part of the dialog, for example, displays default order corresponding to order ID=1 on the details of instruction for order. In a case where the instruction for order in the dialog is changed to “do not order”, the data management apparatus 300 displays information corresponding to the smallest order ID in the item library 210 by default on the details of instruction for order.

After the process in the dialog is completed, the data management apparatus 300 obtains the details of changes in the dialog (step S4), and checks if the order information has changed (step S5). As a result of the checking, if the order information has changed (step S5: YES), then the data management apparatus 300 obtains an instruction for order from the dialog, sets the instruction in the item order property (step S6), obtains the details of instruction for order from the dialog, and sets it in the item order property (step S7). Because of the checking if the order information has changed, if the order information has not changed (step S5: NO), then the data management apparatus 300 terminates the process without changing the item attributes.

As has been described above, in the second embodiment, if the element attributes of the items have changed, such as when the order information is changed from “do order” to “do not order”, the changed order information is set again in the item property. This allows efficient management of data that is used by system integration of an information system to be achieved while coping with changes in the element attributes of items.

### Third Embodiment

Drawing data created at the construction of an information system can be copied and used. For example, there may be a use case in which drawing data that was created at the construction of a system for one customer before is copied and used for construction of a system for another customer.

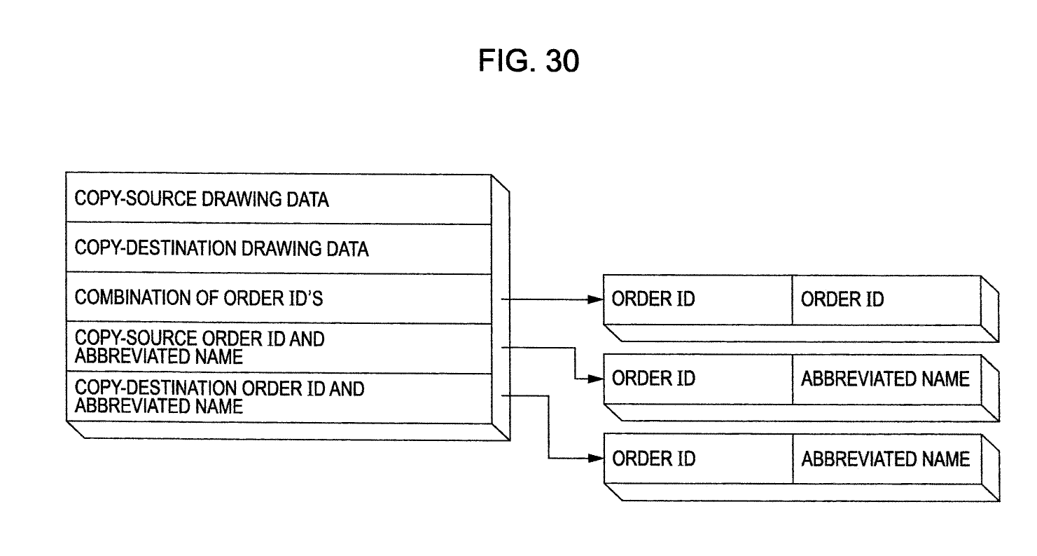

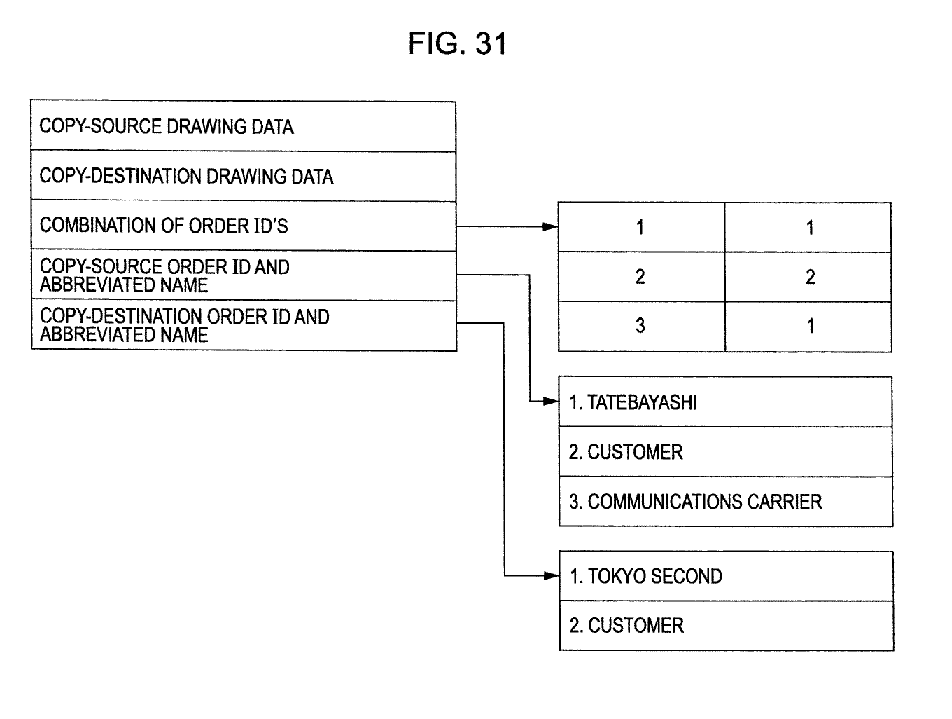

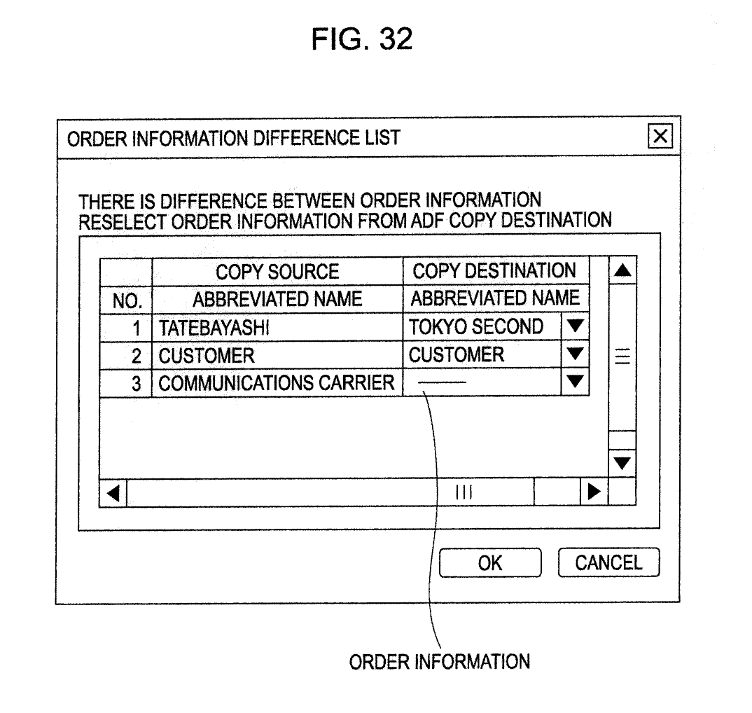

FIG. 30 is a diagram showing comparison objects between order information according to a third embodiment. As shown in the diagram, in the case where a copy of drawing data is used, order information (a combination of order IDs and a combination of order ID and abbreviated name) is compared between copy-source drawing data and copy-destination drawing data. Specifically, as shown in FIG. 31, a combination of order IDs, a combination of order ID and an abbreviated name (order information) are extracted from the individual drawing data. In a case where there is a difference between the extracted order information, the data management apparatus 300 displays the extracted order information on a display or the like. FIG. 31 is a diagram showing an example of the extraction of order information according to the third embodiment. FIG. 32 is a diagram showing an example of the display of the difference between order information according to the third embodiment.

### Process According to Third Embodiment

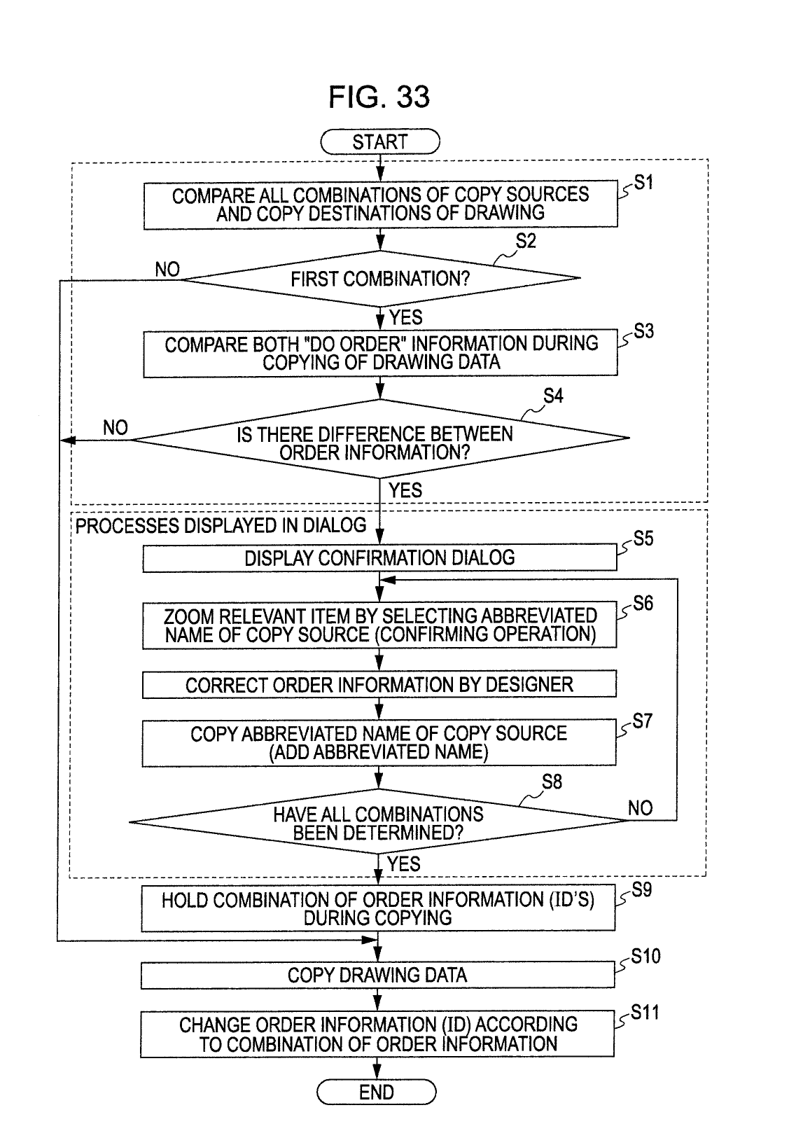

FIG. 33 is a flowchart for the process according to the third embodiment. As shown in the flowchart, the data management apparatus 300 compares the copy source and the copy destination (step S1) to determine whether it is the first combination (step S2).

As a result of the determination, if it is the first combination (step S2: YES), then the data management apparatus 300 compares “do-order information (a combination of order IDs and a combination of order ID and abbreviated name” between copy-source drawing data and copy-destination drawing data (step S3) to determine whether there is a difference between the order information (step S4).

As a result of the determination, if there is a difference between the order information (step S4: YES), then the data management apparatus 300 displays a confirmation dialog (see FIG. 32) (step S5). When receiving selection of copy-source abbreviated name from the user, the data management apparatus 300 zooms a corresponding item by a copy-source-abbreviated-name selecting process (step S6).

After order information is modified or the like by the user who is a system designer, the data management apparatus 300 executes a copy-source-abbreviated-name copying process (adding process) (step S7). For example, in the case shown in FIG. 32, the data management apparatus 300 performs the process of adding an abbreviated name to the portion “-” of the copy destination.

The data management apparatus 300 determines whether all of combinations of abbreviated names have been determined between the copy source and the copy destination (whether there is a portion in which an abbreviated name is absent) (step S8). As a result of the determination, if all the combination of abbreviated names are decided (step S8: YES), then the data management apparatus 300 holds the combinations of order information (order IDs) (step S9) and executes copying of drawing data from the copy source to the copy destination (step S10). After the execution of the copying, the data management apparatus 300 changes the order information (order ID) in accordance with the combination of order information (step S11). For example, in the case shown in FIG. 32, when copy-source drawing data is copied and used, order ID corresponding to the order information of the copy source, “Tatebayashi”, is changed to order ID corresponding to the order information of the copy destination, “Tokyo second”.

Returning to the description of step S2, as a result of the comparison between the order information, if the combination is not the first combination (step S2: NO), then the data management apparatus 300 moves to the processes in step S10 and step S11 described above.

Returning to the description of step S4, as a result of the determination whether there is a difference between the order information, if there is no difference between the order information (step S4: NO), then the data management apparatus 300 moves to step S10 described above and executes copying of drawing data from the copy source to the copy destination.

Returning to the description of step S8, as a result of the determination whether all the combinations of abbreviated names have been decided, if all the combinations of abbreviated names have not been decided (step S8: NO), then the data management apparatus 300 returns to step S6 described above. That is, the data management apparatus 300 receives selection of copy-source abbreviated name from the user who checks an item corresponding to the copy-source abbreviated name and zooms the corresponding item. The processes from step S6 to step S8 described above are executed repeatedly between the copy source and the copy destination until all the combinations of abbreviated names are decided.

As has been described above, since the third embodiment allows drawing data created before at the construction of a system of one customer to be copied and used for constructing another customer's system, smooth operation of an information system can be achieved.

### Fourth Embodiment

An apparatus and a method for managing data according to another embodiment will be described herein below.

(1) Setting Common Order Items and Attachments

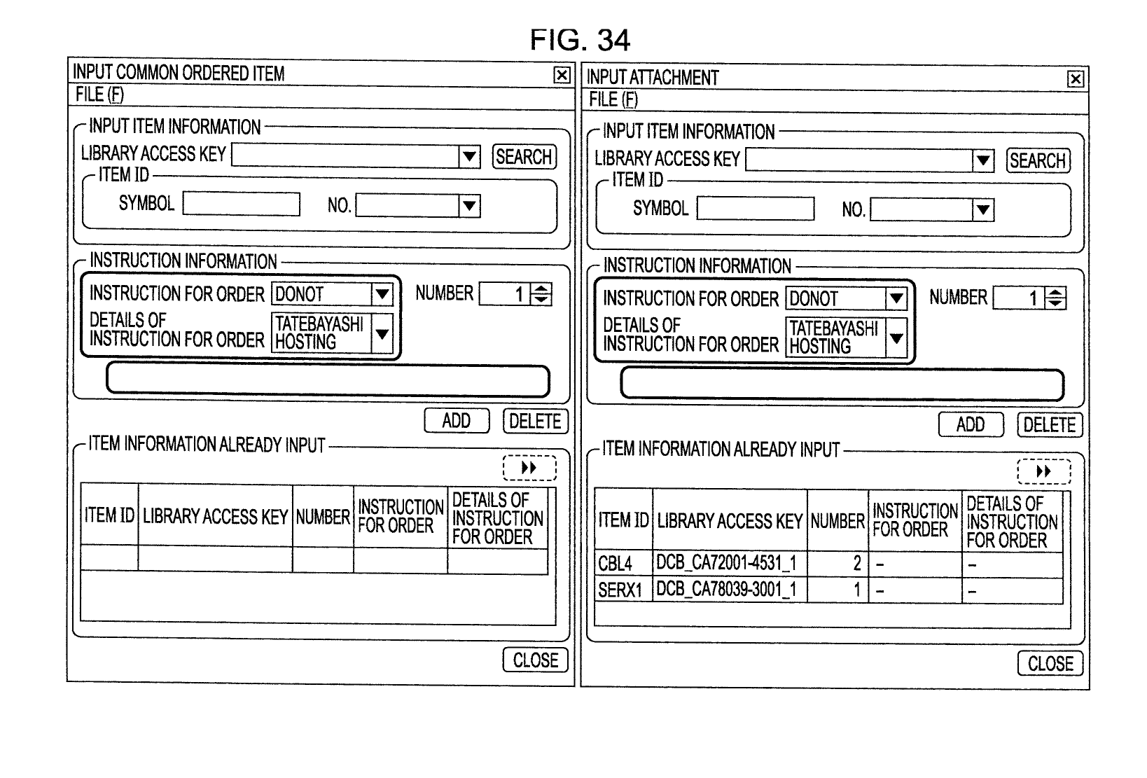

In the above embodiments, as shown in FIG. 34, for example, when constructing an information system, the system designer can set items to be ordered in common or items to be ordered as attachments at the same time when ordering other items. FIG. 34 is a diagram showing a display example of a dialog for setting a common order item and an attachment according to a fourth embodiment.

(2) Apparatus Configuration etc.

The concrete configuration of the distribution and integration of the data management apparatus 300 is not limited to that shown in the diagram; for example, the operation-document generating section 370 and the operation-document output section 380 may be integrated together. In this way, all or part of the data management apparatus 300 can be functionally or physically distributed or integrated in any unit depending on the loads and operating conditions.

Furthermore, all or part of the processing functions (see FIG. 25 etc.) performed by the data management apparatus 300 may be achieved as hardware using wired logic.

(3) Method for Managing Data

A method for managing data, as described below, is achieved using the embodiments described above.

That is, a method for managing data is achieved which includes an order-information managing step of managing order information for individual design drawings for constructing an information system, the order information including do-order information that is uniquely set, when ordering an item, according to the item in association with item information of the item drawn in the design drawings and do-not-order information that is defined in common in the system, when not ordering the item, depending on the reason of not ordering (for example, see FIGS. 16, 17, etc.); and a document generating step of automatically generating a document indicating the order status of the item using the order information managed for the individual design drawings in the order-information managing step (for example, see FIG. 25).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An assembly support apparatus for promotion of an information system, comprising:
a memory for storing design information of the information system including information of a plurality of components necessary for the production of the information system; and
a processor for generating instructions for procurement of the components in accordance with a process comprising;
discriminating the components into those available as inventory items and those that need to be procured from the exterior on the basis of the design information stored in the memory,
urging information of persons responsible to procure the component to be inputted in association with those components to be inputted in association with those components to be produced respectively, and
generating instructions directed to the responsible persons for procurement of those components to be procured from the exterior respectively.

2. The assembly support apparatus according to claim 1, wherein
the processor makes changes to the one of the components information stored into the memory on the basis of the instruction information when change instruction information on one of the components information is input from the exterior.

3. The assembly support apparatus according to claim 1, wherein
the processor further executes
comparing the another design information before updated with the replicated design information when the processor receives the instruction to update another design information using replicated design information, and
outputting the message to request the update of information of the different component when there is a difference in information on the component included in design information as a result of the comparison.

4. A method for assembly support for promotion of an information system by using a processor, the processor being accessible to a memory for storing design information of the information system including information of a plurality of components necessary for the production of the information system, the method comprising:
discriminating the components into those available as inventory items and those that need to be procured from the exterior on the basis of an information acquired by accessing the memory by using the processor,
urging information of persons responsible to procure the component to be inputted in association with those components to be inputted in association with those components to be produced respectively by using the processor, and
generating instructions directed to the responsible persons for procurement of those components to be procured from the exterior respectively by using the processor.

5. A computer-readable recording medium storing a computer program for assembly support for promotion of an information system, the computer being accessible to a memory for storing design information of the information system, the program being designed to make a computer perform the steps of:
discriminating the components into those available as inventory items and those that need to be procured from the exterior on the basis of an information acquired by accessing the memory by using the processor,
urging information of persons responsible to procure the component to be inputted in association with those components to be inputted in association with those components to be produced respectively by using the processor, and
generating instructions directed to the responsible persons for procurement of those components to be procured from the exterior respectively by using the processor.
